(19) United States
(12) Patent Application Publication
(10) Pub. No.: US 2026/0148737 A1
(43) Pub. Date: May 28, 2026

(54) Voice-Enabled AI Chat Agent Optimized for Web Browsers

(71) Applicant: John Alvarez, Wayne, NJ (US)

(72) Inventor: John Alvarez, Wayne, NJ (US)

(21) Appl. No.: 18/960,106

(22) Filed: Nov. 26, 2024

(51) Int. Cl. G10L 15/18; G10L 13/027; G10L 13/033; G10L 15/06; G10L 15/07; G10L 15/22; G10L 21/0208

(52) U.S. Cl. CPC G10L 15/1815; G10L 13/027; G10L 13/033; G10L 15/063; G10L 15/07; G10L 15/22; G10L 21/0208

(57) ABSTRACT

Disclosed herein is a Voice-Enabled AI Chat Agent, optimized for use within web browsers. This advanced AI system facilitates natural, voice-driven interactions, allowing users to engage in conversations through speech instead of traditional text input. It features a sophisticated voice recognition module, a dynamic natural language processing engine, and a versatile role adaptation mechanism, enabling it to assume various user-defined roles such as a tutor, doctor, or counsellor. Designed with an emphasis on accessibility and user-friendliness, this AI chat agent represents a significant advancement in human-computer interaction, making digital communication more intuitive and accessible for a wide range of users.

### TECHNICAL FIELD

This invention relates to the field of Artificial Intelligence (AI), focusing on AI chat agents that interact with users through voice commands in web browsers.

### BACKGROUND

AI chat agents, commonly known as chatbots, have been a cornerstone of AI's application in daily technology. Initially, these agents were rudimentary, programmed with basic decision trees and pre-set responses. As AI evolved, so did these agents, incorporating more sophisticated algorithms like natural language processing (NLP) and machine learning (ML) to better understand and respond to user queries. This evolution marked a significant leap from rigid, keyword-based interactions to more fluid, conversational engagements.

The majority of contemporary AI chatbots are text-based. Users interact with these agents via typing, receiving written responses in return. These chatbots are prevalent in customer service, virtual assistance, and even in personal entertainment. The text-based interface, while universally compatible with various devices and platforms, comes with inherent limitations. Typing as a mode of communication can be slow, less intuitive, and sometimes inaccessible for users with disabilities or those not proficient in typing.

Parallel to the development of AI chatbots, voice recognition technology has seen significant advancements. Products like voice assistants (e.g., Siri, Alexa) have popularized voice-based interactions. Voice recognition offers a more natural and human-like mode of communication. However, its integration into web browsers has been patchy. While some browsers and extensions offer voice recognition capabilities, they are often limited to basic commands and lack deep integration with AI chatbots.

Web browser-based chatbots, until now, have largely been text-dependent. These chatbots fail to leverage the full potential of voice interaction. Users seeking a hands-free, voice-based experience in a web browser environment are left wanting. Moreover, these browser-based chatbots often lack versatility in roles. They are typically designed for specific tasks (e.g., customer service), limiting their applicability to a broader range of user needs.

Another critical aspect where existing solutions fall short is in accessibility. Users with visual impairments, motor disabilities, or those who find typing cumbersome are often unable to fully utilize text-based chatbots. Voice-enabled interfaces can significantly enhance accessibility, allowing a wider range of users to benefit from AI technologies.

Given the limitations of current technologies, there is a clear need for an AI chat agent that is not only voice-enabled but also optimized for the web browser environment. Such an agent would break the barriers of text-based interactions, offering a more inclusive and natural communication experience. Additionally, an AI agent capable of assuming multiple roles (e.g., tutor, advisor, friend) would vastly expand the utility and applicability of browser-based AI technologies.

### SUMMARY

Embodiments of the present disclosure present technological improvements as solutions to one or more of the above-mentioned technical problems recognized by the inventor in conventional solutions.

The invention presents a groundbreaking advancement in the domain of artificial intelligence and human-computer interaction: a Voice-Enabled AI Chat Agent optimized for use in web browsers. The agent represents a significant leap from traditional text-based chatbots, offering a fully voice-interactive experience that enables users to converse in a natural, human-like manner. Uniquely designed to leverage the advanced speech recognition capabilities of the web browsers, it provides an intuitive and accessible user interface, especially beneficial for individuals who find typing cumbersome or have disabilities. Beyond its innovative voice interaction feature, the agent is distinguished by its adaptability to various roles, such as a doctor, tutor, counsellor, or buddy, tailoring its conversational responses and functionalities to the selected role. This adaptability not only enhances the user experience but also broadens the application scope of the agent, making it a versatile tool for diverse needs and scenarios. In essence, this invention addresses the limitations of current text-based AI chatbots by introducing a more natural, accessible, and versatile AI chat agent for the modern web user.

Additional aspects, advantages, features and objects of the present disclosure would be made apparent from the drawings and the detailed description of the illustrative embodiments construed in conjunction with the complete specification that will follow.

It will be appreciated that features of the present disclosure are susceptible to being combined in various combinations without departing from the scope of the present disclosure.

### BRIEF DESCRIPTION OF DRAWINGS

The summary above, as well as the following description of illustrative embodiments are better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those in the art will understand that the drawings are not to scale. Wherever possible, like elements have been indicated by identical numbers.

Embodiments of the present disclosure will now be described, by way of example only, with reference to the following diagrams wherein:

FIG. 1 depicts a block diagram for an exemplary system as per the disclosed invention.

FIG. 2 depicts a flowchart for the method steps as per the disclosed invention.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the nonunderlined number is used to identify a general item at which the arrow is pointing.

### DESCRIPTION OF EMBODIMENTS

The following description illustrates embodiments of the present disclosure and ways in which they can be implemented. Although some modes of carrying out the present disclosure have been disclosed, those skilled in the art would recognize that other embodiments for carrying out or practicing the present disclosure are also possible.

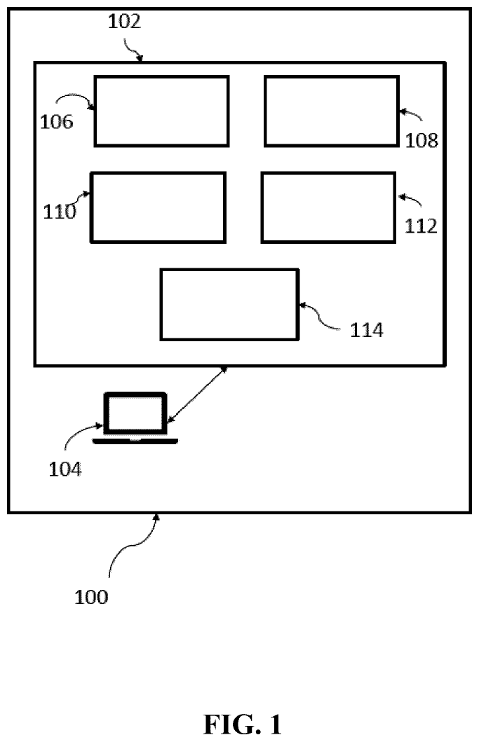

The present invention describes a system and method for generating Voice-Enabled AI Chat Agent Optimized for Web Browsers. FIG. 1 depicts a block diagram for an exemplary system as per the disclosed invention. The system 100 comprises a processor 102 communicably coupled with a user interface 104 wherein the processor 102 further comprises a Voice Recognition Module 106, a Natural Language Processing (NLP) Engine 108, and a response generation module 110. The processor further comprises a role adaptation module 112.

The voice recognition module comprises an audio input interface, a signal processing unit, and a speech-to-text converter. It uses automatic speech recognition (ASR) algorithms based on neural networks to transcribe spoken input into text, supporting various accents, dialects, and noise conditions. The module integrates real-time processing pipelines, enabling seamless interactions.

Upon receiving voice input from the user, the audio interface captures the audio signal, which is pre-processed by the signal processing unit to filter out noise and normalize the sound. The filtered signal is then fed into the ASR system, where it is transcribed into text using trained speech models. For instance, when a user says, “Find the nearest pharmacy,” the module converts the speech to the text command “find the nearest pharmacy,” which is sent to the NLP engine for interpretation. This process ensures low latency and high accuracy, even in noisy environments.

Once captured, these voice inputs are converted into text. This conversion is essential for the subsequent processing stages, allowing the natural language processing (NLP) engine to analyze the user's request.

The converted text is fed into the NLP engine 108, which represents the core of the AI chat agent's intelligence. The NLP engine 108 analyses the text for context and intent. It understands not just the literal meaning of the words, but also the user's intent, using advanced algorithms and contextual analysis. This NLP engine 108 is dynamic and capable of learning from each interaction. It continuously refines its understanding of language and user behaviour, enhancing its response accuracy over time.

The NLP engine 108 consists of a tokenizer, a contextual analyzer, an intent classifier, and a knowledge database interface. It processes the textual data from the voice recognition module by breaking it into manageable tokens, identifying the context, and classifying the user's intent using deep learning models and linguistic heuristics. The textual input is first tokenized to identify key terms and syntactic structure. Next, the contextual analyzer determines the meaning of the input by referencing the knowledge database, while the intent classifier predicts the action requested by the user. For instance, in the command “Find the nearest pharmacy,” the NLP engine recognizes “find” as the action, “pharmacy” as the target, and “nearest” as the contextual modifier. This structured data is sent to the response generation system for reply formulation. Based on the analysis performed by the NLP engine 108, the processor 102 generates a response. This process considers the current context and the historical interaction data to form coherent and relevant responses. The response, initially in text form, is then converted into speech. This conversion utilizes text-to-speech technology, ensuring the response sounds natural and is easily understandable. The response generation system includes a response formulation module, a text-to-speech (TTS) synthesizer, and a tone adaptation mechanism. It generates human-like voice responses based on the processed input from the NLP engine. The response formulation module constructs a grammatically correct reply using the extracted intent and context. This reply is then passed to the TTS synthesizer, which converts the textual response into natural speech. For example, if the system receives the input “What's the weather in New York?”, the response generation module retrieves weather data for New York and formulates a response such as “The weather in New York is currently sunny at 25°C.” The synthesized response is sent back to the user through the interface.

A pivotal feature of the AI chat agent is its ability to adapt to various roles, such as a tutor, doctor, counsellor, or buddy. This adaptability is achieved through a role adaptation mechanism. When a user selects a specific role, the AI chat agent adjusts its response patterns, information database, and interaction style to fit that role. For instance, as a tutor, it accesses educational content, while as a doctor, it taps into medical knowledge. The role adaptation mechanism comprises a role definition library, a context-switching module, and a behavioral database. It dynamically adjusts the AI agent's conversational style, vocabulary, and tone based on the predefined role relevant to the interaction. When a user interaction begins, the system determines the role based on user input or session type. The role definition library configures the AI agent's responses. For instance, in a technical support session, the mechanism adopts a structured and instructional style, while in a sales inquiry, it switches to a persuasive tone. This ensures that the AI agent adapts to the requirements of diverse use cases, such as customer service or troubleshooting.

The user interface (UI) 104 is streamlined and intuitive, designed for easy use within a web browser, particularly Google Chrome. The UI facilitates voice activation and control, with optional text support.

The optimization for Google Chrome ensures that the chat agent utilizes the browser's advanced speech recognition capabilities for maximum efficiency and accuracy.

In an embodiment of the present invention, all voice interactions are encrypted, protecting the data transmission between the user and the AI chat agent. The system adheres to strict privacy protocols, ensuring user data is handled securely. Users have the option to review and delete their interaction history, giving them control over their data.

The processor 102 further comprises a machine learning module 114 that allows it to adapt and improve based on user interactions. This machine learning module 114 analyses interaction patterns, user feedback, and engagement metrics to enhance its conversational abilities.

In another aspect, the system is equipped with adaptive learning capabilities in the voice recognition module and the NLP engine, allowing the system to improve performance over time based on user interactions. The voice recognition module integrates a feedback loop mechanism, an adaptive speech model, and a user-specific profile database. It learns from user interactions to refine its recognition accuracy, especially for unique accents, speech patterns, or vocabulary. When the system encounters misinterpretations, it stores the corrected input in the user-specific profile database. Over time, the adaptive speech model incorporates this data to enhance recognition performance. For example, if a user frequently mispronounces certain words, the module adjusts its model to accommodate these variations, thereby providing more accurate transcriptions in subsequent interactions.

Further, the NLP engine includes a reinforcement learning module, a dynamic intent-matching framework, and a contextual refinement mechanism. It uses feedback from user interactions to improve its understanding of context and intent. As users provide corrective feedback or exhibit specific interaction patterns, the reinforcement learning module adjusts the intent-matching framework. For instance, if a user frequently uses colloquial expressions or domain-specific jargon, the system learns to map these inputs to the correct intents. Over time, this adaptation enhances the relevance and accuracy of responses.

In yet another embodiment, the AI chat agent includes features for enhanced accessibility. For users with hearing impairments, text support is available, allowing them to interact with the AI chat agent effectively.

The AI chat agent is designed with the capability to integrate with other web services and platforms. This feature allows for expanded functionality, such as accessing external databases or services to provide more comprehensive responses and services.

The system is designed to be compatible with standard desktop hardware, requiring no special equipment. It is resource-efficient, ensuring that it does not degrade the performance of the user's device or the web browser.

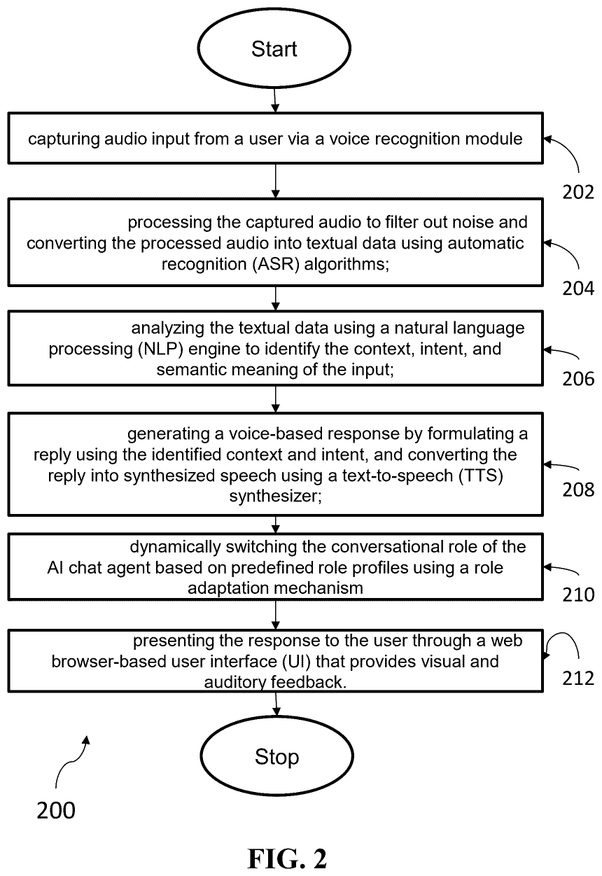

FIG. 2 depicts a flowchart 200 for the method steps as per the disclosed invention. At step 202, audio input from a user is captured via a voice recognition module. Next at step 204, the captured audio is processed to filter out noise and converting the processed audio into textual data using automatic recognition (ASR) algorithms. At step 206, the textual data is analysed using a natural language processing (NLP) engine to identify the context, intent, and semantic meaning of the input. At step 208, a voice-based response is generated by formulating a reply using the identified context and intent, and converting the reply into synthesized speech using a text-to-speech (TTS) synthesizer. Further, at step 210, the conversational role of the AI chat agent is dynamically switched based on predefined role profiles using a role adaptation mechanism. Finally, at step 212, the response is presented to the user through a web browser-based user interface (UI) that provides visual and auditory feedback.

Method steps of the invention may be performed by one or more processors executing a program tangibly embodied on a computer-readable medium to perform functions of the invention by operating on input and generating output. Suitable processors include, by way of example, both general and special purpose microprocessors. Generally, the processor 102 receives (reads) instructions and data from a memory (such as a read-only memory and/or a random-access memory) and writes (stores) instructions and data to the memory. Storage devices suitable for tangibly embodying computer program instructions and data include, for example, all forms of non-volatile memory, such as semiconductor memory devices, including EPROM, EEPROM, and flash memory devices; magnetic disks such as internal hard disks and removable disks; magneto-optical disks; and CD-ROMs. Any of the foregoing may be supplemented by, or incorporated in, specially-designed ASICs (application-specific integrated circuits) or FPGAs (Field-Programmable Gate Arrays).

A processor 102 can generally also receive (read) programs and data from, and write (store) programs and data to, a non-transitory computer-readable storage medium such as an internal disk (not shown) or a removable disk.

One or more components of the invention are described as modules for the understanding of the specification. For example, a module may include self-contained component in a hardware circuit comprising of logical gate, semiconductor device, integrated circuits or any other discrete component. The module may also be a part of any software programme executed by any hardware entity for example processor. The implementation of module as a software programme may include a set of logical instructions to be executed by a processor or any other hardware entity.

Additional or less modules can be included without deviating from the novel art of this disclosure. In addition, each unit can include any number and combination of sub-units, and systems, implemented with any combination of hardware and/or software units.

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Reference to the singular is also to be construed to relate to the plural.

1. A method for enabling a voice-enabled AI chat agent, comprising:
capturing audio input from a user via a voice recognition module;
processing the captured audio to filter out noise and converting the processed audio into textual data using automatic speech recognition (ASR) algorithms;
analyzing the textual data using a natural language processing (NLP) engine to identify the context, intent, and semantic meaning of the input;
generating a voice-based response by formulating a reply using the identified context and intent, and converting the reply into synthesized speech using a text-to-speech (TTS) synthesizer;
dynamically switching the conversational role of the AI chat agent based on predefined role profiles using a role adaptation mechanism; and
presenting the response to the user through a web browser-based user interface (UI) that provides visual and auditory feedback.

2. The method of claim 1, further comprising adapting the voice recognition module to improve speech-to-text conversion accuracy by incorporating user feedback and updating speech recognition models.

3. The method of claim 1, further comprising retrieving contextual information from an external database via the NLP engine to enhance the relevance of the generated response.

4. The method of claim 1, wherein dynamically switching the conversational role includes detecting a change in the interaction context and automatically reconfiguring the AI agent to adopt a different predefined role.

5. The method of claim 1, further comprising providing live textual transcriptions of voice input and synthesized voice responses via the web browser-based user interface.

6. The method of claim 1, further comprising adjusting the tone and style of synthesized speech output in real time based on user preferences or detected interaction sentiment.

7. The method of claim 1, wherein the NLP engine and voice recognition module are configured to iteratively refine their respective models by applying machine learning techniques to user interaction data.

8. A system for a voice-enabled AI chat agent, comprising:
a voice recognition module configured to capture audio input, process the audio signal to filter noise, and convert the processed audio into textual data using automatic speech recognition (ASR) algorithms;
a natural language processing (NLP) engine operatively connected to the voice recognition module, configured to analyze the textual data to identify context, intent, and semantic meaning using a tokenizer, a contextual analyzer, and an intent classifier;
a response generation system operatively connected to the NLP engine, configured to generate voice-based responses by formulating contextually appropriate replies and converting the replies into synthesized speech using a text-to-speech (TTS) synthesizer;
a role adaptation mechanism operatively connected to the response generation system, configured to dynamically switch the conversational behavior of the AI chat agent between multiple predefined roles, wherein each role is associated with distinct conversational patterns, vocabulary, and tone; and
a user interface (UI) optimized for web browsers, configured to enable user interaction through voice input, provide real-time visual feedback, and display the system's responses in textual and audio formats;
wherein the voice recognition module and the NLP engine are further configured to learn and adapt to user-specific speech patterns, contextual preferences, and interaction behaviors over time by incorporating user feedback and iterative updates to machine learning models.

9. The system of claim 8, wherein the voice recognition module includes noise cancellation filters and adaptive processing algorithms to improve speech-to-text conversion accuracy in high-noise environments.

10. The system of claim 8, wherein the NLP engine further comprises a knowledge database interface configured to retrieve contextual information from external or internal databases to enhance the relevance of the identified intent.

11. The system of claim 8, wherein the response generation system includes a tone adaptation mechanism configured to adjust the emotional tone, pace, and style of synthesized speech based on the identified role of the AI chat agent.

12. The system of claim 8, wherein the role adaptation mechanism is further configured to switch conversational roles dynamically during a single interaction based on real-time context changes detected by the NLP engine.

13. The system of claim 8, wherein the learning and adaptation capabilities of the voice recognition module and the NLP engine utilize reinforcement learning techniques to refine speech recognition and intent analysis models based on aggregate user interactions.

14. The system of claim 8, wherein the role adaptation mechanism includes a role definition library and a behavioral database, wherein each role is associated with predefined conversational rules and personality traits to tailor the AI chat agent's responses.

15. The system of claim 8, wherein the NLP engine further includes a dynamic intent-matching framework configured to improve intent classification for domain-specific queries based on cumulative interaction data.
